(19) United States
(12) Patent Application Publication
(10) Pub. No.: US 2018/0010363 A1
(43) Pub. Date: Jan. 11, 2018

(54) A LOCK

(71) Applicant: ZEDLOCK LIMITED, West Sussex (GB)

(72) Inventor: Bruce Daniel ROBERTSON, West Sussex (GB)

(21) Appl. No.: 15/547,110

(22) PCT Filed: Nov. 18, 2015
(86) PCT No.: PCT/GB2015/000300

§ 371 Date: Jul. 28, 2017

(30) Foreign Application Priority Data
Jan. 30, 2015 (GB) GB1501542.3
Feb. 2, 2015 (GB) GB1501719.7
Feb. 9, 2015 (GB) GB1502053.0

(51) Int. Cl. E05B 17/20; E05C 1/04; E05B 65/00

(52) U.S. Cl. CPC E05B 17/2038; E05B 65/0007; E05C 1/04

(57) ABSTRACT

The invention relates to a lock (5) for a hinged closure, comprising a housing (8) adapted to be mounted on a frame (3) of the closure, and seating internally thereof a bolt device (4) reciprocable relative to the housing between respective open and closed positions of the closure and having a throw of substantially 70 mm to bridge in use a gap between the frame and a facing keeper, characterised by a Eurocylinder lock means (5) adapted to engage and retain the bolt (4) in the locked, or closed, position of the closure. There is also disclosed means to protect the said lock (5) against vandalism, the means comprising in disclosed embodiments a cover plate (305,305a), an inclined escutcheon (6), or smooth fillet weld(s) securing the escutcheon (6) to the housing (8).

The invention relates to a lock, and particularly to a lock for a hinged closure for providing securing and/or locking of a closure such as an agricultural or farm gate.

Such agricultural gates are often of metal or wood, and are hinged at one end of a frame thereof to a gate post, being latched shut by a latch mechanism and padlock on an opposite side of the frame engaging with an adjacent gate post. Such mechanisms are vulnerable to damage or vandalism as they are externally mounted on the gate closure, and there is often a relatively large gap between the opposite side of the frame and the adjacent gate post. Livestock or equipment in a field can be stolen if the mechanism is damaged or vandalised, leading to expensive losses and also repairs to or replacement of the gate enclosure.

It is an object of the invention to seek to mitigate these disadvantages.

According to one aspect of the invention there is provided a lock for a hinged closure, comprising a housing adapted to be mounted on a frame of the closure, and seating internally thereof a bolt device reciprocable relative to the housing between respective open and closed positions of the closure and having a throw of substantially 70 mm to bridge in use a gap between the frame and a facing keeper, there being Eurocylinder lock means adapted to engage and retain the bolt device in use in the closed position of the closure.

It will be understood that the term Eurocylinder lock means refers to a lock means which usually has a cylinder in which a rotatable barrel is mounted and which can be turned to and from an open, unlocked, and closed, locked position by a key to operate key pins to move spring-loaded driver pins to a shear line defining a boundary between the barrel and cylinder so that the barrel can be rotated on turning the key. There is also a cam secured to the barrel having a part which operates a lock of the closure. When the barrel rotates, so does the cam so that the cam part operates the lock.

The Eurocylinder lock means may suitably be mounted in the housing above the bolt device.

The Eurocylinder lock means may be key-operated. This provides a suitable operation.

The Eurocylinder lock means may be mounted in an escutcheon element carried by the housing. This provides for ease of construction.

The escutcheon element may protrude from opposite faces of the housing. This provides for ease of mounting of the Eurocylinder lock means when it has a length greater than the depth of the housing. Thus the escutcheon element may protrude up to 15 mm from the plane of each opposite face of the housing, and is adapted thereby to receivev and protect the Eurocylinder lock means.

The lock may comprise means to protect the Eurocylinder lock against vandalism, which means may comprise a cover device.

The cover device may comprise a plate secured to the housing and covering access to the cylinder of the Eurocylinder lock. Preferably the plate may extend substantially parallel to, and proud of, a body of the housing.

Suitably the body of the housing may be defined by opposite boundary suefaces, and there may preferably be a plate secured to each said boundary surface.

A locks for a hinged closure are hereinafter described, by way of example, with reference to the accompanying drawings.

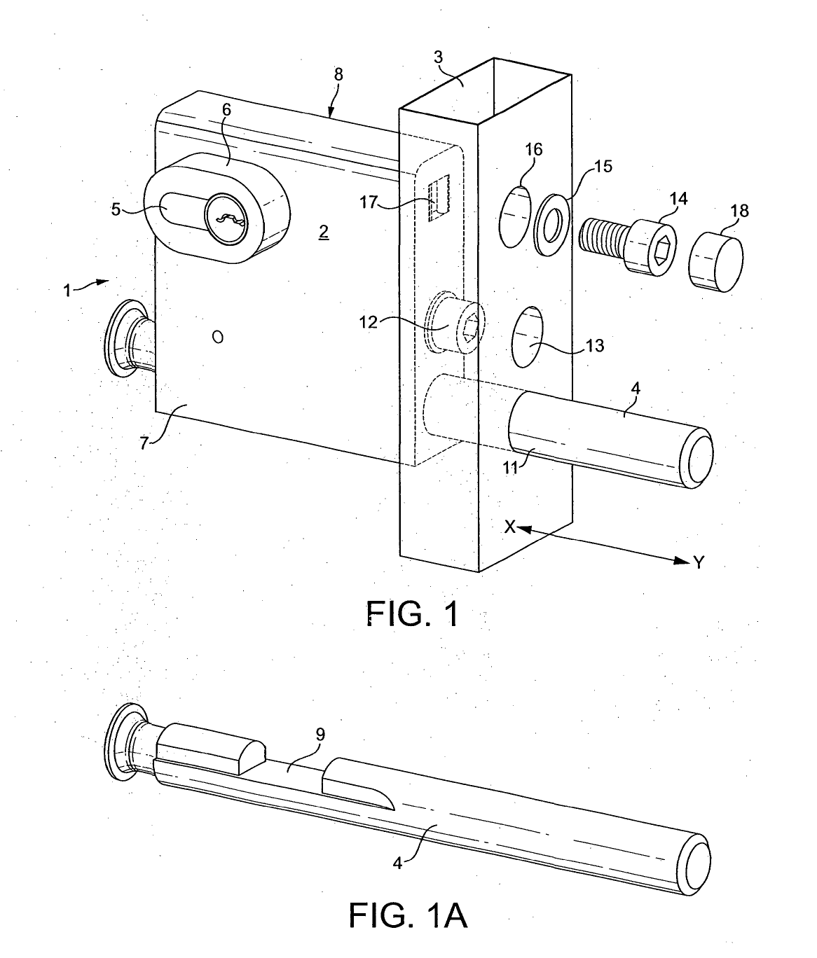

FIG. 1 is a schematic perspective view of a lock embodying the invention and a part of a frame of a hinged closure;

FIG. 1A is to an enlarged scale a schematic perspective view of a reciprocable bolt device of the lock;

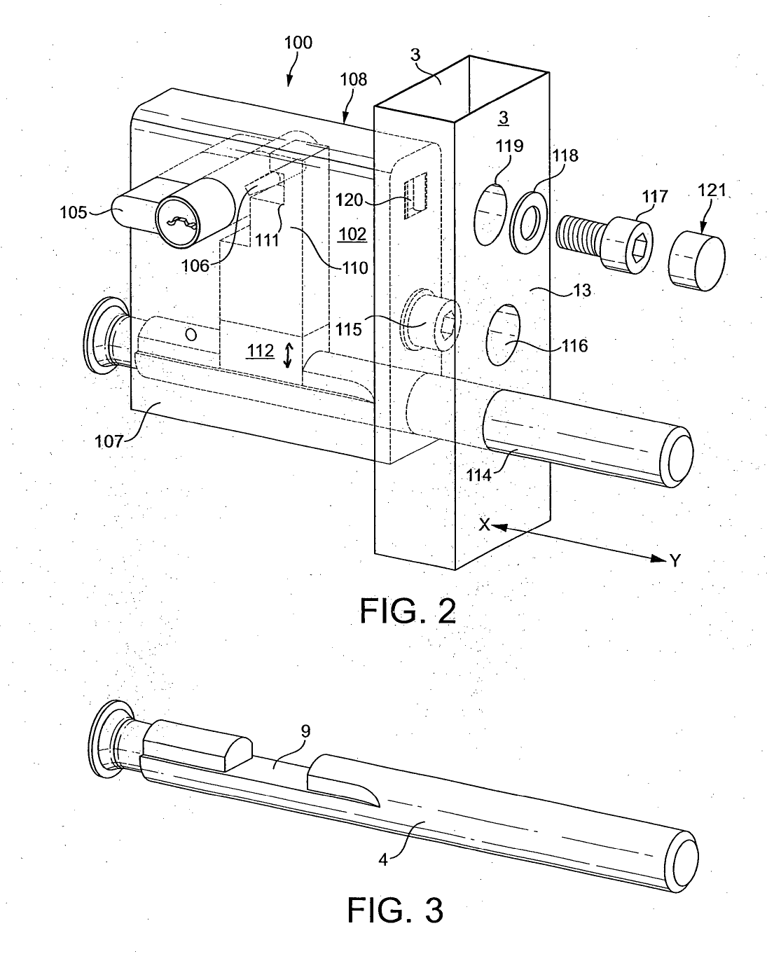

FIG. 2 is a schematic perspective view of a second lock embodying the invention and part of a frame of a hinged closure;

FIG. 3 is to an enlarged scale relative to FIG. 2 a schematic perspective view of a reciprocable bolt device of the lock;

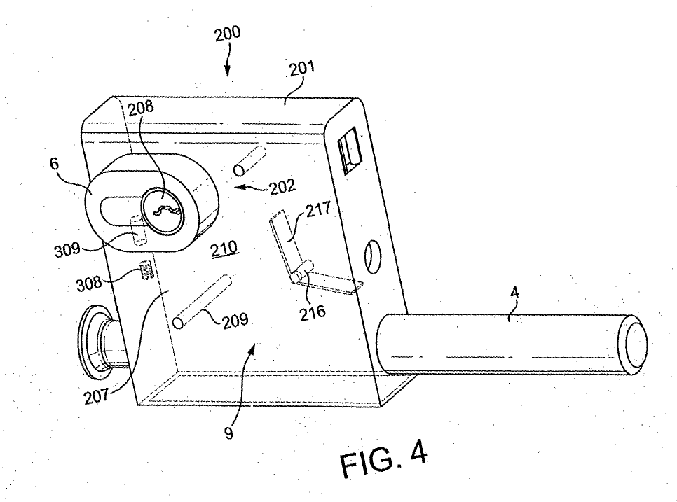

FIG. 4 is a schematic perspective view of a third embodiment of lock embodying the invention with internal parts shown;

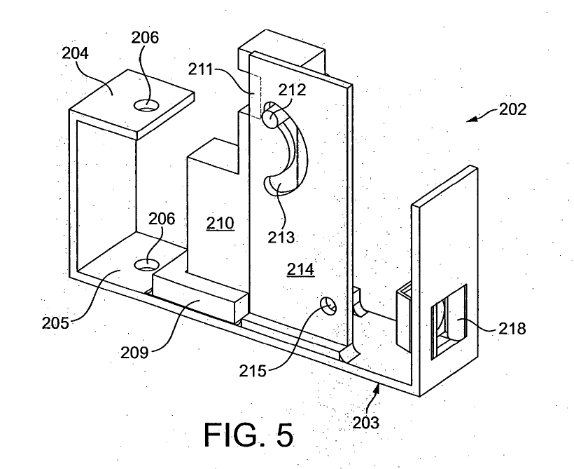

FIG. 5 is a schematic perspective view of part of an internal mechanism of the lock;

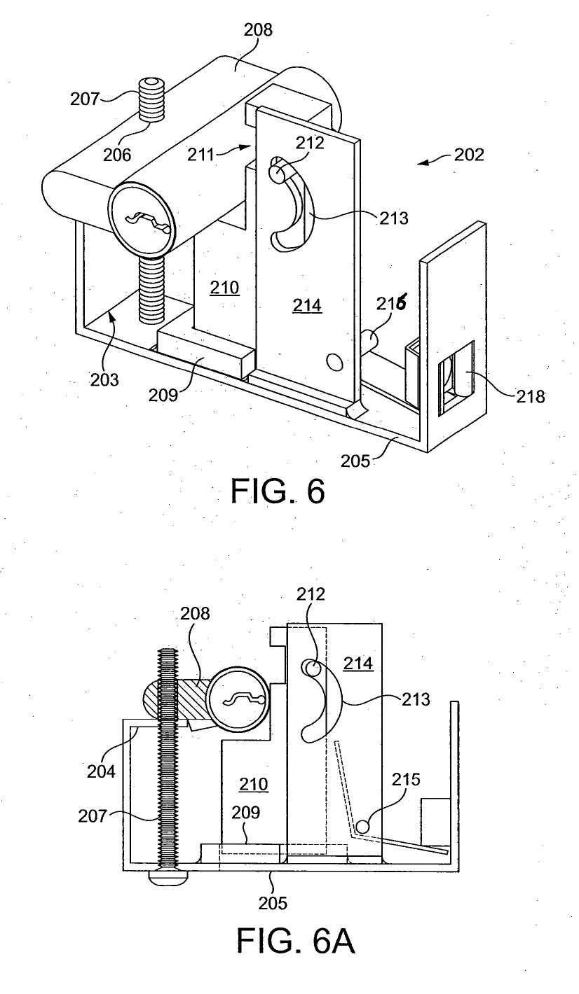

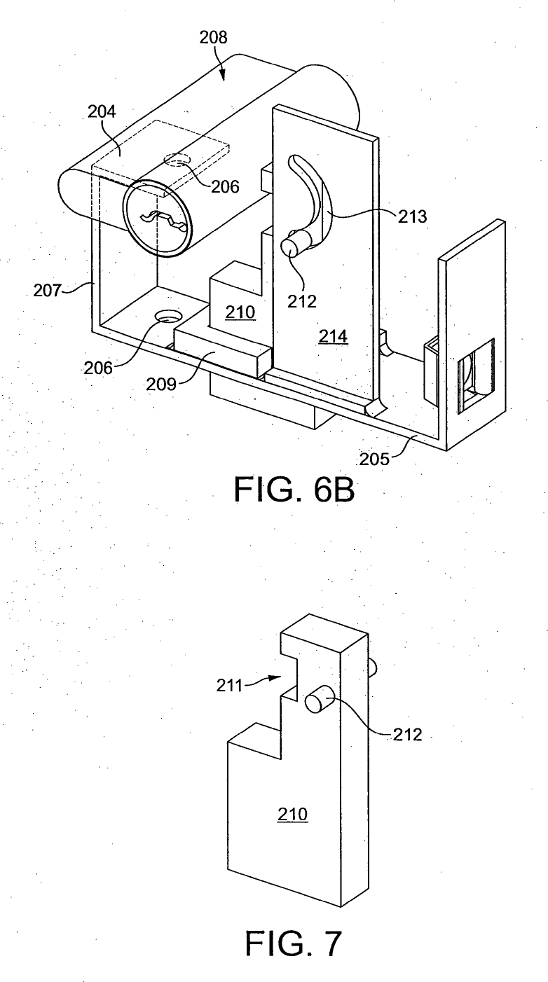

FIG. 6 is a schematic perspective detail view of the part mechanism of FIG. 5 with a Eurocylinder lock in place;

FIG. 6A shows a schematic side elevation detailed view of the combined components of inter alia FIGS. 5 and 6 with a dead-bolt being in the open position of the lock (dead-bolt retracted);

FIG. 6B shows a schematic side elevation detailed view of the combined components of inter alia FIGS. 5 and 6 with a dead-bolt being in the closed position of the lock (dead-bolt extended);

FIG. 7 shows a schematic perspective view of the dead-bolt of FIGS. 4 to 6B; and

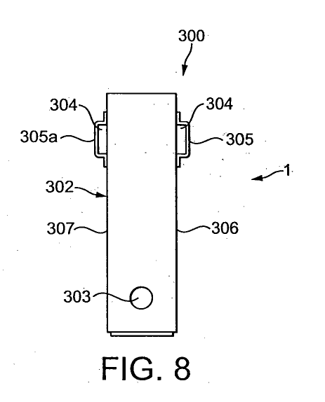

FIG. 8 is a schematic rear elevational view of a further embodiment of lock embodying the invention.

In the drawings, like parts are referred to for clarity by like numerals.

Referring to FIGS. 1 and 1A of the drawings, there is shown a lock 1 for a hinged closure, comprising a housing 2 adapted to be mounted on a hollow frame 3 of the closure, and seating internally thereof a bolt device 4 reciprocable relative to the housing 2 between respective open and closed positions of the closure and having a throw of substantially 70 mm to bridge in use a gap between the frame 3 and a facing keeper (not shown), there being a Eurocylinder lock 5 adapted to engage and retain the bolt device 4 in use in engagement with the keeper in the closed position of the closure.

The Eurocylinder lock 5 is mounted in an escutcheon plate 6 having a seating of generally key-hole shape for receiving the Eurocylinder lock 5. The depth of the housing 2 in the embodiment is about 30 mm, and the length of the Eurocylinder lock 5 is about 60 mm, the escutcheon plate 6 protruding from opposite main, substantially parallel, faces 7 and 8 of the housing 2 by about 15 mm from each main face 7, 8 to accommodate the Eurocylinder lock 5. The escutcheon plate 6 acts as a seating for the Eurocylinder lock 5 and protects it from attack for example by a monkey wrench or saw, the escutcheon plate being made of hardened steel for this purpose.

The manually reciprocable bolt device 4 is mounted in the housing 2, which is hollow to accommodate the bolt device 4 and Eurocylinder lock 5. The bolt device 4 has a rebate or notch 9 intermediate its length for receiving an operative element in the form of the cam of the Eurocylinder lock 5, which cam engages and retains the bolt device 4 in use in engagement with the keeper in the closed position of the closure to provide secure locking of the closure even when there is a significant gap to be bridged, the bolt device having a throw of about 70 mm from the housing so that in use it can extend across such a gap of up to or about 50 mm between the housing and a facing keeper.

The housing has an open lower face (not shown) defined by inturned, facing and spaced apart flanges extending longitudinally of the housing, there being a follower secured to the bolt device which is positioned internally of the housing as shown in FIG. 1 and in parallel with the flanges so that the follower is located between and in cooperation with the flanges for guiding the bolt device during longitudinal reciprocation thereof.

In use, the lock 1 is secured to the inner face of upright frame member 10 of the closure frame 3, which upright 10 has a through orifice 11 aligned with the bolt device 4 for allowing it to move over its 70 mm throw, as shown at X-Y in FIG. 1. There is also a projection 12 from the housing to locate in a seating 13 of the frame member 10 to provide a positive seating for the lock 1. The lock 1 is secured by a bolt 14 and washer 15 which bolt 14 passes through an orifice 16 in the upright into a screw-threaded seating 17 in the facing face of the housing 2. The bolt head is covered by a security cap 18, suitably of plastic.

Referring now to FIGS. 2 and 3 of the drawings, there is shown a lock 100 for a hinged closure 101, comprising a housing 102 adapted to be mounted on a frame 3 of the closure, and seating internally thereof a bolt device 4 reciprocable, preferably manually, relative to the housing 102 between respective open and closed positions of the closure and having a throw of substantially 70 mm to bridge in use a gap between the frame 3 and a facing keeper (not shown), there being Eurocylinder lock 105 adapted to engage and retain the bolt device 4 in use in engagement with the keeper in the closed position of the closure.

The Eurocylinder lock 105 is mounted in an escutcheon plate (not shown, but like that 6 of FIG. 1) having a seating of generally key-hole shape for receiving the Eurocylinder lock 105. The depth of the housing 102 in the embodiment is about 30 mm, and the length of the Eurocylinder lock 105 is about 60 mm, the escutcheon plate protruding from opposite main, substantially parallel, faces 107 and 108 of the housing 102 by about 15 mm from each main face 107, 108 to accommodate the Eurocylinder lock 105. The escutcheon plate acts as a seating for the Eurocylinder lock 105 and protects it from attack for example by a monkey wrench or saw, the escutcheon plate being made of hardened steel for this purpose.

The manually reciprocable bolt device 4 is mounted in the housing 102, which is hollow to accommodate the bolt device 4 and Eurocylinder lock 105. The bolt device 4 has a rebate or notch 9 intermediate its length.

The Eurocylinder lock 105 has a cam 106 secured to the rotatable barrel of the lock 105. Internally of the housing 102 of the lock 100 and between its faces 107, 108 there is an operative element in the form in the embodiment of a substantially vertically reciprocable operative means 110 in the form of a dead-bolt which has a cut-out, notch or mortice 111 for receiving the cam 106. The end of the deadbolt 110 opposite the notch 111 has a portion or foot 112 of lateral extent such as to allow the foot 112 to be received relatively snuggly in the notch 9 of the bolt device 4. Stated in another way, the notch 9 and foot 112 are in the embodiment shown a close fit.

In operation, the foot 112 can be engaged with, and disengaged from, the bolt device 4. This is achieved by operation of the Eurocylinder lock 105. When the barrel is rotated anti-clockwise by a key (not shown), the cam 106 rotates likewise and lifts the deadbolt 110 vertically by bearing on the upper boundary surface of the notch 111 to disengage the foot 112 of the deadbolt 110 from the notch 9 of the bolt device when the bolt device 4 is in the closed position of the closure. The bolt device 4 can then be manually reciprocated, to the left as viewed, to free the bolt device 4 from the keeper and allow the closure to be opened. In the locked position of the closure with the bolt device 4 engaged in the keeper, rotation clockwise of the barrel and hence of the cam 106 of the Eurocylinder lock 105 urges the cam 106 against the lower boundary face of the notch 111 to move the deadbolt 110 downwardly to engage the foot 112 in the notch 9, the deadbolt 110 it will be understood being positioned to be above the notch 9 in the closed position of the closure. The deadbolt thus engages and retains the bolt device 4 in use in engagement with the keeper in the closed position of the closure to provide secure locking of the closure even when there is a significant gap to be bridged, the bolt device having a throw of about 70 mm from the housing so that in use it can extend across such a gap of up to or about 50 mm between the housing and a facing keeper. The upward and downward movements, to provide the respective open position and closed position of the closure, of the foot 112 integral with the deadbolt 110 are shown by the double-headed arrow in FIG. 2.

The deadbolt 110 is guided in its reciprocable substantially vertical movement by sliding in contact with the inner surfaces of the faces 107,108 of the housing 102, or alternatively by additional guide members, not shown, internally of the housing.

It will be understood that the interengagement of the cam 106 and operative element 110 provide means by which the Eurocylinder lock 105 is adapted to engage and retain the bolt device 4 in use in engagement with the keeper in the closed position of the closure.

The housing 102 has an open lower face (not shown) defined by inturned, facing and spaced apart flanges extending longitudinally of the housing, there being a follower secured to the bolt device 4 which is positioned internally of the housing as shown in FIG. 2 and in parallel with the flanges so that the follower is located between and in cooperation with the flanges for guiding the bolt device during longitudinal reciprocation thereof.

In use, the lock 100 is secured to the inner face of upright frame member 10 of the closure frame 3, which upright 10 has a through orifice 114 aligned with the bolt device 4 for allowing it to move over its 70 mm throw, as shown at X-Y in FIG. 2. There is also a projection 115 from the housing to locate in a seating 116 of the frame member or upright 3 to provide a positive seating for the lock 100. The lock 100 is secured by a bolt 117 and washer 118 which bolt 117 passes through an orifice 119 in the upright 3 into a screw-threaded seating 120 in the facing face of the housing 102. The bolt head is covered by a security cap 121, suitably of plastic.

It will be understood that in this embodiment the dead-bolt 110 acts as a mortice lock operable to engage in the rebate or notch 9 in the bolt device 4.

Referring now to FIGS. 4 to 7, there is shown a third embodiment of lock 200 for a hinged closure, FIG. 4 showing a schematic perspective view of the lock with internal components shown in phantom. As in the first and second embodiments, the lock 200 has a body 201 comprising an external housing and a manually reciprocable bolt 4 having a rebate or notch 9 therein adapted to receive a dead-locking mechanism 202 internally of the housing 201, as shown in FIGS. 4 to 6B.

The components of the dead-locking mechanism 202 comprise in the embodiment a frame 203 which at the left-hand end as viewed is a U-configuration, substantially vertically spaced-apart limbs 204, 205 of which have aligned through holes 206. These holes 206 in use receive means in the form of a bolt or screw 207 which passes through the holes and an aligned hole in the body of a Eurocylinder lock 208 to secure that lock in position in the housing 201.

The lower in use limb 205 extends laterally to the right as viewed beyond the free end of the upper limb 204 and mounts a seating or guide 209 by which a dead-bolt 210 is guided for reciprocable substantially vertical movement into engagement with and withdrawal from a rebate or notch 9 in the manually slidable bolt 4 on rotation of the cam (not shown) of the Eurocylinder lock 208, which cam engages in a seating in the form of a notch or mortice 211 for this purpose. As shown, the dead-bolt 210 also has a transverse pin 212 which extends externally laterally thereof providing free ends. The free left-hand end of this pin 212 engages in guide means in the form of a curved blind slot, or groove, 213 in a plate element in the form of a bracket 214 which is also mounted on the lower limb 205 and extends substantially vertically therefrom and is in running contact with an adjacent face of the dead-bolt 210. There is a through hole 215 in the bracket 214 which receives a horizontal pin 216, the head of which is flush with the outer (as viewed) surface of the bracket.

The pin 216 extends across the interior of the housing 201 and provides a fulchrum or guide round which biasing means in the form of a flat spring 217 made of spring steel and being of lazy-L shape in the embodiment passes. The spring 217 has a free end which bears against the right hand face as viewed of the dead-lock 210 to hold the dead-lock under tension and in place for smooth operation. The spring 217 has an end opposite the free end which seats in the housing 201 below a cage nut 218. It will be understood that in a modification, not shown, the flat spring may be replaced by a torsion spring wound round the pin 216, opposite ends of the torsion spring bearing respectively against the deadbolt and a part of the interior of the housing to provide a positive mounting and smooth operation of the deadbolt.

In use, when a key is inserted in the barrel of the Eurocylinder lock 208 and rotated clockwise, the cam of the Eurocylinder lock engages a surface of a mortice 211 of the dead-bolt 210 as the key is turned and urges the dead-bolt downwardly as viewed. The downward movement of the dead-bolt is positively guided by the pin 212 travelling in an arc in the curved slot 213 in the dead-bolt frame 214. The dead-bolt 210 travels sufficiently for it to enter the rebate or notch 9 in the slidable bolt 4 and locks that bolt in the closed position, the bolt having previously been extended from the housing across the gap to engage in the keeper in the frame. The bolt 4 is thus locked in the closed position. Further turning of the key allows it to be withdrawn from the barrel of the Eurocylinder lock, leaving the closure dead-locked shut. A reverse procedure, ie turning the key anti-clockwise after insertion in the barrel of the Eurocylinder lock withdraws the dead-bolt 210 from the rebate or notch 9 thereby allowing the manually reciprocably slidable bolt 4 to be withdrawn from the keeper and the closure or gate to be opened. Further rotation of the key allows it to be withdrawn from the barrel of the Eurocylinder lock 208.

Referring now to FIG. 8 of the drawings, there is shown a lock 300 for a hinged closure, comprising a housing 302 adapted to be mounted on a frame of the closure, and seating internally thereof a bolt device 303 slidably reciprocable, preferably manually, relative to the housing 302 between respective open and closed positions of the closure and having a throw of substantially 70 mm to bridge in use a gap between the frame and a facing keeper, Eurocylinder lock 304 adapted to engage and retain the bolt device 303 in use in engagement with the keeper in the closed position of the closure, and means 305 to protect the Eurocylinder lock against vandalisation.

The means 305 in the embodiment shown is a cover device in the form of a sheet metal, suitably hardened steel, plate secured to a front boundary surface 306 of the housing 302, being spaced from the boundary surface 306 to cover the front face of the lock means 300, it being understood that the plate 305 will include an orifice aligned with the lock entry for a key, and just wide enough to receive the width of a shank of the key used to operate the lock 304 when inserted in the entry for operation of the lock. In this position, a hand-grippable part of the key will be outside the plate 305, to the right as viewed, and will ride over the surface 6 of the plate when the key is turned.

In the embodiment, a rear surface 407 of the housing also has a plate 305a covering the rear of the lock, which protrudes from the surface 307.

The or each plate 305, 305a is/are secured to their respective surface 306, 307 by any suitable means such as welding. Thus in use, the plates 305, 305a prevent ready access to the escutcheon by bolt cutters, shears, saws, hammers or the like, and thus provide a defence against attempted vandalism of the lock.

In a modification, not shown, the upper and lower surfaces of the escutcheon are inclined or tapered towards one another in a direction away from the body, the upper surface downwardly and the lower surface upwardly so as to provide surfaces on which bolt cutters, pliers, saws and the like find it difficult to find a purchase as they slip off, so obviating vandalism. In yet another anti-vandalism embodiment, also not shown, the escutcheon plate is welded to the outer main surfaces of the housing 302 by curved fillet welds which again in make it difficult for bolt cutters, shears, saws and the like to find a purchase as they slip off.

Another anti-vandalisation modification is shown in FIG. 4, there being in that embodiment a grub screw 308 screwed up through a hole 309 in the escutcheon 6 to engage either with a friction fit on the body of the Eurocylinder lock or in a blind hole in that lock. The head of the grub screw 308 is smoothed off or filled with a filler such as metal or resin so that it cannot readily be accessible, so providing a protection against vandalism.

In every embodiment, apart from the escutcheon and plates 305,305a, the components are made of mild steel.

1-35. (canceled)

36. In a lock for a hinged closure, comprising a housing adapted to be mounted on a frame of the closure, and seating internally thereof a bolt device reciprocable relative to the housing between respective open and closed positions of the closure and having a throw of substantially 70 mm to bridge in use a gap between the frame and a facing keeper, the improvements comprising a Eurocylinder lock means adapted to engage and retain the bolt device, the said Eurocylinder lock means being mounted in the housing above the bolt device by an escutcheon element which is carried by the housing, the said bolt device comprising a rebated portion intermediate its length to receive an operative element of the Eurocylinder lock means, the said operative element comprising a substantially vertically reciprocable element adapted to engage in and disengage from the rebated portion whereby in use the bolt device is in engagement with the keeper in the closed position of the lock.

37. A lock as defined in claim 36, the Eurocylinder lock means being key-operated and the bolt device being manually reciprocable.

38. A lock as defined in claim 36, the housing comprising spaced apart opposite faces and the escutcheon element protruding from the said opposite faces of the housing.

39. A lock as defined in claim 38, the escutcheon element protruding up to 15 mm from the plane of each opposite face of the housing.

40. A lock as defined in claim 36, the Eurocylinder lock means (5) comprising a cam, the said cam and operative element being adapted to be in operative engagement, whereby the Eurocylinder lock means is adapted to provide respective locked and unlocked positions of the bolt device.

41. A lock as defined in claim 40, the operative element comprising a deadbolt and a mortice adapted to receive the cam, and a foot adapted to be engaged in and withdrawn from the rebated portion.

42. A lock as defined in claim 41, comprising biasing means adapted to engage the deadbolt for urging the mortice to receive the cam.

43. A lock as defined in claim 41, comprising guide means adapted to guide the deadbolt during substantially vertical reciprocal motion thereof, the guide means comprising follower means extending from the deadbolt.

44. A lock as defined in claim 43, the said guide means being carried by a support plate adapted to bear against an adjacent face of the deadbolt, the follower means comprising a pin.

45. A lock as defined in claim 44, the guide means comprising a slot through the support plate and in which the pin is received.

46. A lock as defined in claim 44, the guide means comprising a curved slot through the support plate and in which the pin is received.

47. A lock as defined in claim 41, comprising biasing means being selected from a group comprising a spring plate, a torsion spring, and a spring plate of substantially lazy- L configuration.

48. A lock as defined in claim 47, a free end of a limb of the ‘L’ bearing against the deadbolt.

49. A lock as defined in claim 36, comprising protection means adapted to protect the Eurocylinder lock against vandalism and comprising a cover device mounted on one or each of two boundary surfaces of the housing.

50. A lock as defined in claim 36, comprising a gripping device engaging through the escutcheon element into a body of the Eurocylinder lock means whereby to hold the said Eurocylinder lock means in position in the housing.

51. A lock as defined in claim 36, there being protection means for the lock selected from the group comprising surfaces of the escutcheon element inclined towards one another from the housing, a fillet weld means supporting the escutcheon, and weld means configured to curve away from the housing.

52. In a gate closure comprising a frame hingedly mounted on a gate post on one side of the frame and being lockable to a further gate post on the opposite side of the frame to the one side of the frame, the improvement of a combination with a lock as defined in claim 36 secured by the housing to the opposite side of the frame, the opposite side of the frame and the further gate post comprising a keeper having orifices alignable in the closed position of the gate closure, such that the bolt device is adapted to extend through the orifice in the opposite side frame into the orifice in the further post across the gap between the said gate posts whereby to secure the gate closure closed.

53. A gate closure as defined in claim 52, the housing being secured to the opposite side frame by screw-threaded securing devices and the frame being selected from a group comprising metal and wood.

54. A gate closure as defined in claim 52, comprising a shield device adapted to protect any exposed part of the bolt device in the closed position of the gate closure.

55. A gate closure as defined in claim 52, comprising metal double gates, the frame of one of which mounts the lock, said bolt device of which lock is reciprocable into and out of a seating in a substantially vertically slidable elongate device mounted on a facing frame of the other gate, the said vertically slidable elongate device being locatable in a housing set in the ground.
